(19) United States
(12) Patent Application Publication
(10) Pub. No.: US 2007/0297726 A1
(43) Pub. Date: Dec. 27, 2007

(54) Multi-Fiber Ferrule and A Mold Therefore

(75) Inventors: Darrell R. Childers, Hickory, NC (US); Eric Childers, Conover, NC (US)

Correspondence Address: Michael L. Leetzow, Esq.;Michael L. Leetzow, P.A., 5213 SHORELINE CIRCLE, SANFORD, FL, 32771, US

(73) Assignee: US CONEC LTD., Hickory, NC (US)

(21) Appl. No.: 11/849,721

(22) Filed: Sep. 12, 2007

Related U.S. Application Data
(62) Division of application No. 10/999,398, filed on Nov. 29, 2004.

(51) Int. Cl. G02B 6/36; B28B 7/28

(52) U.S. Cl. 385/78; 249/175

(57) ABSTRACT

A ferrule has at least one row of optical fiber openings to hold optical fibers. The ferrule also includes a lead-in portion for each of the optical fiber openings to assist in positioning the optical fibers into the optical fiber openings in the ferrule. The optical fiber openings in the ferrule are slightly smaller and have a similar spacing allowing for better fill between the optical fiber openings. A mold core that corresponds to the ferrule is disclosed. The mold core encapsulates at least a portion of the optical fiber opening forming pins, eliminating build up and breakage of the pins.

The present invention relates to a multi-fiber ferrule, and more particularly, a multi-fiber ferrule having at least one row of openings for optical fibers and a lead in portion for each of the openings in the ferrule. The present invention also relates to a mold core that is used to mold the multi-fiber ferrule.

There are prior art ferrules including, for example, ferrules that have single and multiple rows of optical fiber bores. These ferrules typically have voids in and between the optical fiber bores due to the method used for molding the ferrules. Typically, the pins used to make the optical fiber bores are epoxied together before being inserted into mold. This is a highly labor intensive exercise and presents a risk that the pins will break during removal of the mold core from the mold and or the molded ferrules from the mold. The optical fiber bore forming pins are 250 microns in diameter and when inserted into the mold are spaced with a pitch of 250 microns. This arrangement leads to an inconsistent fill and even large areas of voids, allowing optical fibers to cross over in the optical fiber bores and to be stubbed upon insertion into the ferrule. Additionally, the optical fiber bore forming pins are difficult to replace if one breaks at any point in the process, reducing the productivity of the mold.

Accordingly, the present invention is directed to an optical ferrule and mold that substantially obviates one or more of the problems and disadvantages in the prior art. Additional features and advantages of the invention will be set forth in the description that follows, and in part will be apparent from the description, or may be learned by practice of the invention. The objectives and other advantages of the invention will be realized and attained by the apparatus and process particularly pointed out in the written description and claims, as well as the appended drawings.

### SUMMARY OF THE INVENTION

To achieve these and other advantages and in accordance with the purpose of the invention as embodied and broadly described herein, the invention is directed to a multi-fiber ferrule for securing at least one row of optical fibers, the at least one row of optical fibers comprising at least two optical fibers, the multi-fiber ferrule includes a first row of optical fiber openings, the optical fiber openings having a pitch and each of the optical fiber openings extending from a front face through at least a portion of the ferrule to a first plane, the first plane disposed between the front face and a rear face of the ferrule, and a first stepped portion, the first stepped portion disposed between the first plane and the rear face of the ferrule and having a plurality of grooves, each of the plurality of grooves in communication with a respective one of the optical fibers openings in the first row to provide a lead-in portion for each of the optical fiber openings in the first row, and each of the grooves having a width that is at least 10 microns smaller than the pitch of the optical fiber openings.

In another aspect, the invention provides for a multi-fiber ferrule for securing at least one row of optical fibers, the at least one row of optical fibers comprising at least two optical fibers, the multi-fiber ferrule includes a first row of optical fiber openings, each of the optical fiber openings extending from a front face through at least a portion of the ferrule to a first plane, the first plane disposed between the front face and a rear face of the ferrule, and a first stepped portion, the first stepped portion disposed between the first plane and the rear face of the ferrule and having a plurality of grooves, each of the plurality of grooves having a width and a depth and being in communication with one of the optical fibers openings in the first row to provide a lead-in portion for the first row of optical fiber openings, and the width of each of the grooves being greater than the depth.

In yet another aspect, the invention is directed to a mold core used to mold a ferrule that secures at least one row of optical fibers, the mold core includes a main body portion, a plurality of openings extending through the main body portion, a first stepped portion adjacent the main portion, and a plurality of grooves in the stepped portion and in communication with the plurality of openings in the main portion.

In yet another aspect, the invention is directed to a mold core used to mold a ferrule that secures at least two rows of optical fibers, the mold core includes a main body portion, the main body portion having at least a first stepped portion and a second stepped portion, a plurality of openings extending through the main body, the plurality of openings comprising at least a first plurality of openings and at least a second plurality openings, the first stepped portion encapsulating only a portion of each of openings in the first plurality of openings and the second stepped portion encapsulating only a portion of the openings in the second plurality of openings to provide a lead in portion for each of the plurality of openings in the main body portion.

In another aspect, the invention is directed to a mold core used to mold a ferrule that secures at least one row of optical fibers, the mold core includes a main body portion, the main body portion including a plurality of openings extending therethrough, a plurality of opening forming pins configured to be disposed in a respective one of each of the plurality of openings, and a reduced portion, the reduced portion being a portion of the main body portion and being configured to encapsulate a portion of each of the plurality of opening forming pins disposed in the openings.

It is to be understood that the foregoing general description and the following detailed description are exemplary and explanatory and are intended to provide further explanation of the invention as claimed.

The accompanying drawings are included to provide a further understanding of the invention and are incorporated in and constitute a part of the specification. The drawings illustrate several embodiments of the invention and together with the description serve to explain the principles of the invention.

### BRIEF DESCRIPTION OF THE DRAWINGS

FIG. 1 is a perspective view of one embodiment of a ferrule according to the present invention;

FIG. 2 is a perspective view of the front end of the ferrule in FIG. 1;

FIG. 3 is a perspective view of a partial cross section of the ferrule of FIG. 1;

FIG. 3 is a partial perspective view of cross section of the ferrule of FIG. 1;

FIG. 4a is an enlarged perspective view of a cross section of the ferrule of FIG. 1;

FIG. 4b is an enlarged partial cross section view through one of the rows of optical fiber openings of the ferrule of FIG. 1;

FIG. 5a is a partial perspective view of another embodiment of a ferrule according to the present invention;

FIG. 5b is a cross section view of a portion of the ferrule of FIG. 5a along the line 5b-5b;

FIG. 6a perspective view of one embodiment of a mold core according to the present invention;

FIG. 6b is an enlarged view of a portion of the mold core of FIG. 6a;

FIG. 7 is an end view of the mold core of FIG. 6a;

FIG. 8 is the back end view of the mold core of FIG. 6a;

FIG. 9 is a perspective view of another embodiment of a mold core according to the present invention; and

FIG. 10 is a fiber optic opening forming pin used with the mold cores in the present invention.

### DETAILED DESCRIPTION OF THE INVENTION

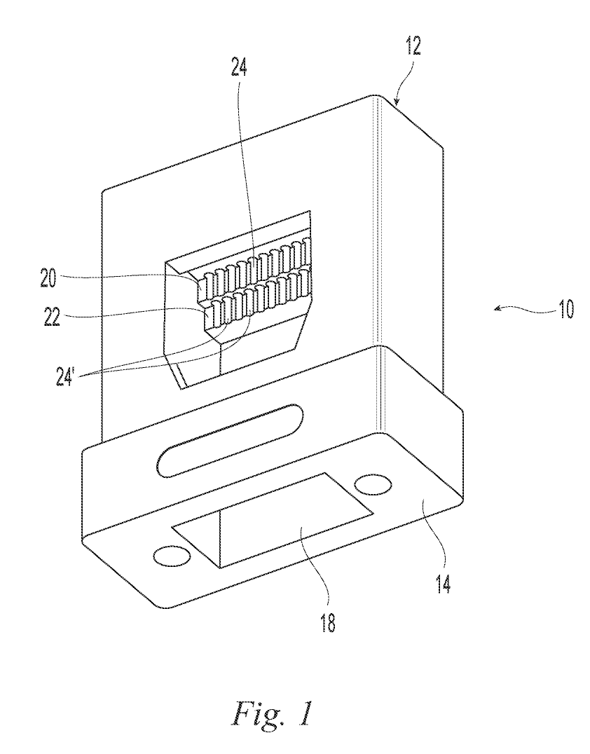

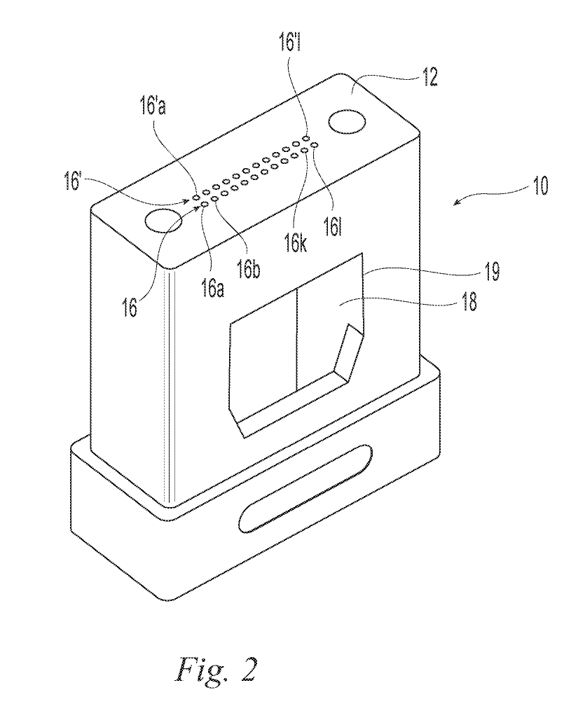

A multi-fiber ferrule 10 according to one embodiment of the present invention is illustrated in FIGS. 1-4b. The multi-fiber ferrule 10 has a front face 12 and a rear face 14. The multi-fiber ferrule 10 has at least one row of optical fiber openings 16 extending from the front face 12 toward the rear face 14 and opening into an opening 18 toward the rear of the ferrule 10. The ferrule 10 also preferably has a window 19 on one of the sides of the ferrule to allow for additional access to the opening 18. In the embodiment illustrated in FIGS. 1-4b, the multi-fiber ferrule 10 has two rows 16,16′ of optical fiber openings. The optical fiber openings in each of the rows (i.e., 16a,16b . . . 16k,16l of row 16 and 16a′ . . . 16l′ of row 16′) are illustrated as round holes, but could be of any appropriate shape. For example, they could be oval, diamond shaped, v-shaped grooves, or squares.

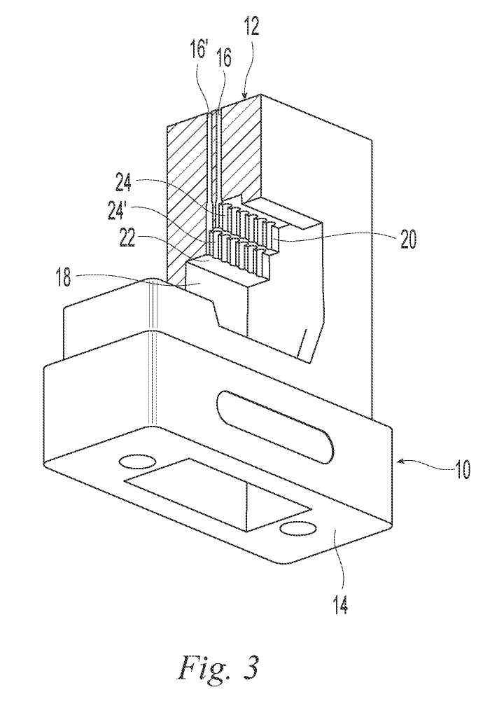

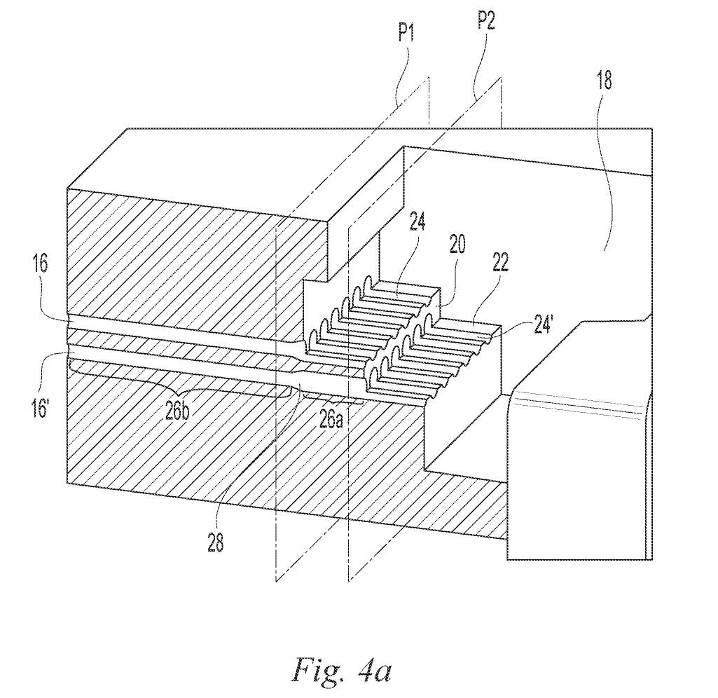

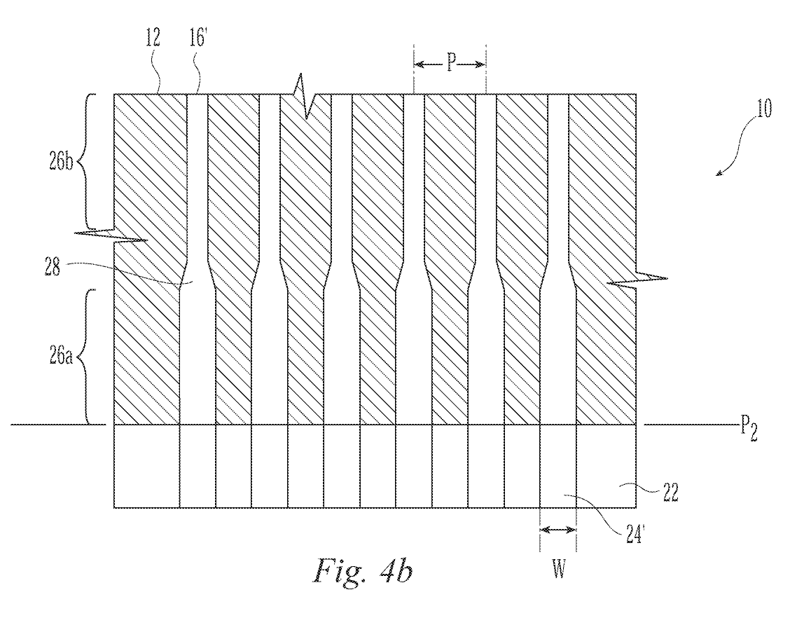

The rows of optical fiber openings 16,16′ open into the opening 18 of the multi-fiber ferrule 10, as best seen in FIGS. 3, 4a & 4b. The openings in rows of optical fiber openings 16,16′ have a pitch P, which is approximately 250 microns. The multi-fiber ferrule 10 also has two stepped portions 20, 22 in rear opening 18. Each of the stepped portions 20,22 has a plurality of grooves 24,24′, and each of the grooves in the plurality of grooves 24,24′ correspond to one of the openings in the rows of optical fiber openings 16,16′, respectively. The grooves 24,24′ act as a lead-in portion for the optical fibers that are to be inserted into the rows of optical fiber openings 16,16′. The grooves 24,24′ are preferably wider than they are deep and, as can be seen in FIG. 4b, are not as wide as the pitch P, to allow for appropriate ferrule material to fill in between each of the grooves 24,24′ and the openings 16,16′ during molding.

As illustrated in FIGS. 3, 4a, and 4b, each of the optical fiber openings 16a . . . 16l and 16a′ . . . 16l′, have two portions, a first portion 26a that is in direct communication with a groove 24,24′ on the stepped portion (20,22), and then a more elongated and more narrow portion 26b that extends to the front face 12 and more closely approximates the size of the optical fibers that are mounted in the multi-fiber ferrule 10. The first portion 26a has preferably the same radius (and shape) as the grooves in stepped portions to allow the smooth insertion of the optical fibers (not shown). The optical fiber openings 16,16′ preferably have a narrowing portion 28 between the first portion 26a and the second portion 26b to allow the optical fibers to be smoothly inserted into the second portion 26b from the first portion 16a. While the first portion 26a in row 16′ is longer than the first portion 26a for row 16, they could be the same lengths or reversed in their lengths.

The first row of optical fiber openings 16 extends from the front face 12 of the ferrule 10 toward the rear face 14 to a plane P1. The plane P1 is positioned between the front face 12 and the rear face 14. Similarly, the second row of optical fiber openings 16′ extends from the front face 12 toward the rear face 14 to a plane P2. Plane P1 is preferably located between the front face 12 and the second plane P2. Similarly, plane P2 is preferably located between plane P1 and the rear face 14. Additional rows of optical fiber openings would be similarly disposed relative to one another, with the openings along similarly placed planes.

The grooves 24,24′ in the stepped portions 20,22 preferably have, as indicated above, the same radius and shape as the fiber optic openings 16,16′ near the respective plane (P1, P2). In the preferred embodiment illustrated in FIGS. 1-4b, the grooves 24,24′ have a generally round configuration that circumscribes less than 180° of a circle. This configuration allows for easy placement of the optical fibers (typically presented into the ferrule 10 in an optical fiber ribbon) into the respective optical fiber openings 16,16′.

The rows of fiber optic openings 16,16′ at the first portion 26a are preferably approximately 180 microns in diameter, and are preferably about 2000 microns long along the first portion 26b. The fiber optic openings 16,16′ at the second portion 26b are preferably about 125 microns in diameter. The individual fiber optic openings as well as the rows of fiber optic openings 16,16′ preferably have a 250 micron pitch in the ferrule 10. This pitch, which is consistent with the spacing in the industry, allows for a consistent fill of the ferrule material (typically thermoplastic) along the length of the ferrule 10, when the diameter of each opening is less than the pitch. It should be noted that since the grooves circumscribe less than 180°, each groove is wider than it is deep. Moreover, since the diameter of each groove is 180 microns and the pitch is 250 microns, there is sufficient space between each groove for the ferrule material to completely fill therebetween.

While there are two rows 16,16′ of optical fiber openings illustrated in ferrule 10, it is contemplated that the ferrule 10 may have only one row of optical fiber openings, more than two rows of optical fiber openings, or any number of rows of optical fiber openings. Furthermore, while 12 openings have been shown in each row of ferrule 10, there may also be more or fewer openings in each row.

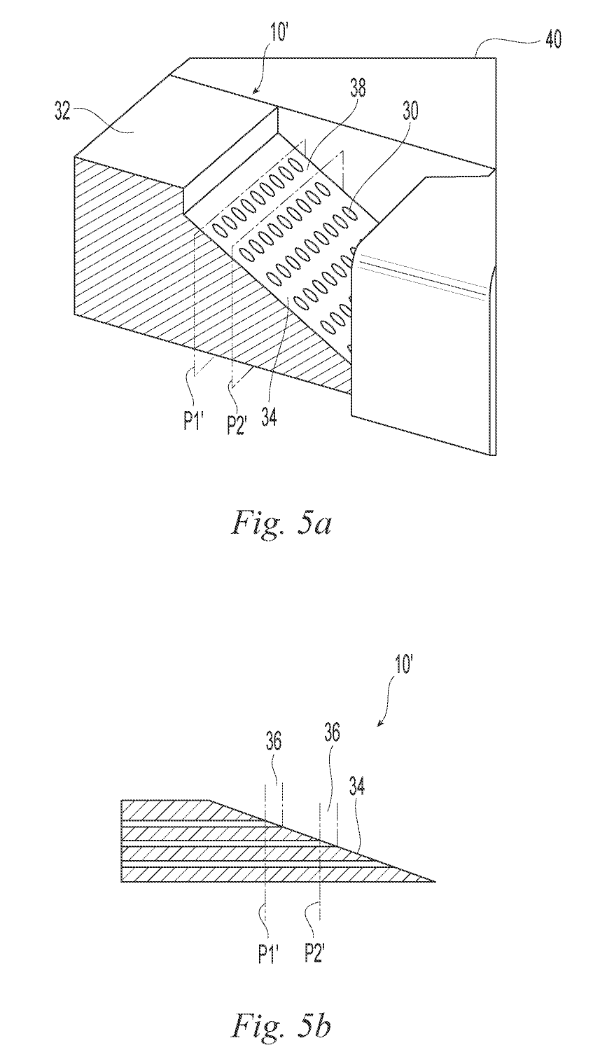

In an alternative embodiment of a ferrule according to the present invention, a portion of which is illustrated in FIG. 5, the ferrule 10′ has a plurality of rows of optical fiber openings 30. As with the above embodiment, the ferrule 10′ has a front face 32 and the rows of optical fiber openings extending from the front face 32 toward to the rear of the ferrule. Rather than having stepped portions as in the previous embodiment, the ferrule 10′ has a sloped region 34. The optical fiber openings 30 are illustrated to be round, but may be of any shape, including oval, rectangular, square, or any other appropriate configuration. The fiber optic openings 30 intersect the sloped portion 34 to provide a lead-in portion 36 for inserting the optical fibers into the optical fiber openings 30. A first row 38 of fiber optic openings 30 extend to a plane P1′ and the lead-in portion 36 corresponding to the fiber optic openings in that row extend from that plane P1′ toward the rear of the ferrule. A second row 40 of fiber optic openings 30 extend to a plane P2′ with the lead-in portion 36 corresponding to that row of fiber optic openings also extends rearwardly. As with the prior embodiment, the lead-in portion 36, which are grooves as a result of the openings 30 opening into the sloped portion 34, for the first row 38 of optical fiber openings 30 is between the first plan P1′ and second plane P2′. Similarly, the lead-in portion for the second row 40 of optical fiber openings is between the first plane P1′ and the rear of the ferrule 10′.

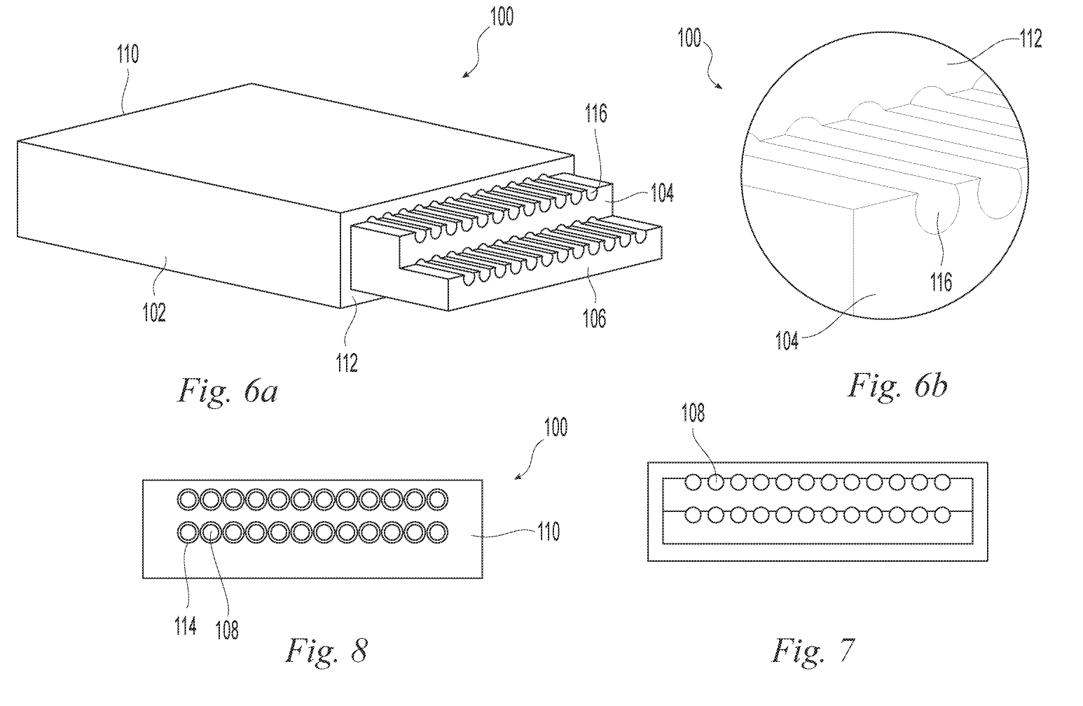

One preferred embodiment of a mold core used to form a multi-fiber ferrule is illustrated in FIGS. 6a-8. The mold core 100 has a main body portion 102 and two stepped portions 104,106. While the illustrated mold core 100 is illustrated with 2 stepped portions, it may have one stepped portion or more than two stepped portions, depending on the number optical fibers to be secured in a multi-fiber ferrule.

The main body portion 102 has openings 108 extending from a rear face 110 to the front face 112. The openings 108 also preferably have an enlarged portion 114 around the openings 108 on the rear face 110 to accommodate a shoulder on the fiber optic opening pins, described in more detail below. In the preferred embodiment, the openings 108 are round (cylindrical along their length), but could be of any shape to hold optical fiber opening forming pins that would be appropriate for forming openings that hold the optical fibers as noted above with respect to ferrules 10,10′.

The openings 108 open into stepped portions (104,106) at the front face 112 of the main body 102 forming grooves 116. The grooves 116 are, as extensions of the openings 108, also generally round in configuration. As can be best seen in FIG. 7, the stepped portions extend from the main body, but do not completely encapsulate the entirety of the openings 108. In fact, as seen in FIGS. 6b and 7, the stepped portions encapsulate slightly more than half of the openings 108, or slightly more than 180° degrees of the openings 108 that extend into the stepped portions 104,106. With the fiber optic opening forming pins having more than half of the circumference being encapsulated by the mold core 100, the fiber optic opening forming pins will not move during injection of the ferrule material into the mold, preventing the material used to form the ferrules (i.e., polymer) from building up between the pins and the mold core. When the ferrule material builds up between the pins the and mold core, causing the pins to move, the lead-in portion (24,24′ of the ferrule 10 described above) of the multi-fiber ferrules may not be coaxial with the optical fiber openings, making insertion loss of the connector higher. Additionally, the fiber optic opening forming pins are less likely to break if they do not move, reducing the costly and time consuming practice of replacing the broken pins.

As noted above with respect to ferrule 10, the openings are preferably 180 microns in diameter and have a 250 micron pitch to correspond to the openings in the ferrule. With the increased distance between each of the openings 108 and the resultant openings in ferrule 10, a better fill is achieved between the rows of openings 16,16′ in the ferrule, reducing the possibility of optical fibers stubbing or crossing over in the openings.

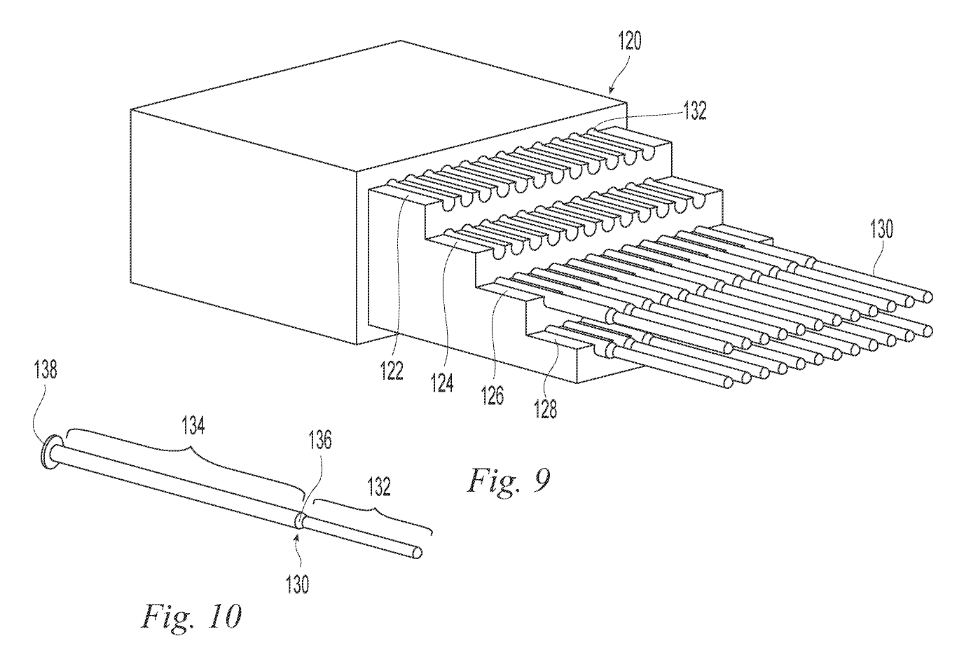

FIG. 9 illustrates another embodiment of a mold core 120 according to the present invention. The mold core 120 is similar to the mold core 100, but has four rows of holes and stepped portions 122,124,126,128 functioning as lead-in portions as described above. The mold core 120 as illustrated has optical fiber opening forming pins 130 inserted into several rows of openings 132. Again, the rows of openings 132 are the same as described above. One example of the one of the optical fiber opening forming pins 130 is illustrated in FIG. 10. The optical fiber opening forming pin 130 has a front portion 132 that forms the opening in the ferrule that opens through the front face (generally corresponds to 26b in ferrule 10 in FIG. 4). The front portion 132 is preferably about 125 microns in diameter, generally corresponding to the size of a bare optical fiber that is secured in optical fiber ferrules. The optical fiber opening forming pin 130 also has a back portion 134 that is larger, preferably about 180 microns in diameter, and is used to create the lead-in portions of the ferrule noted above. The optical fiber opening forming pin 130 preferably has a narrowing portion 136 between the front portion 132 and back portion 134, which corresponds to the narrowing portion 28 in ferrule 10. An enlarged portion 138 is at the back end of the optical fiber opening forming pin 130 to prevent pin 130 from being pulled through the mold core 120 when the ferrules are removed. While the enlarged portion 138 is illustrated to be a circular member (designed to cooperate with the enlarged portion 114 around the openings 108 on the rear faces of mold cores), it could be of any shape and size to prevent the pins from being pulled through the mold cores. For example, the enlarged portion could simply be a tab, a half circle, an oval, or any other appropriate shape.

It will be apparent to those skilled in the art that various modifications and variations can be made in the integrated optical module interface of the present invention without departing from the spirit or scope of the invention. Thus, it is intended that the present invention cover the modifications and variations of this invention provided they come within the scope of the appended claims and their equivalents.

1-9. (canceled)

10. A mold core used to mold a ferrule that secures at least one row of optical fibers, the mold core comprising:
a main body portion;
a plurality of openings extending through the main body portion;
a first stepped portion adjacent the main portion; and
a plurality of grooves in the stepped portion and in communication with the plurality of openings in the main portion.

11. The mold core according to claim 10, wherein the grooves approximate a hole.

12. The mold core according to claim 10, wherein the grooves encapsulate more than 180° of a circle in cross section.

13. A mold core used to mold a ferrule that secures at least two rows of optical fibers, the mold core comprising:
a main body portion, the main body portion having at least a first stepped portion and a second stepped portion;
a plurality of openings extending through the main body, the plurality of openings comprising at least a first plurality of openings and at least a second plurality openings, the first stepped portion encapsulating only a portion of each of openings in the first plurality of openings and the second stepped portion encapsulating only a portion of the openings in the second plurality of openings to provide a lead in portion for each of the plurality of openings in the main body portion.

14. A mold core used to mold a ferrule that secures at least one row of optical fibers, the mold core comprising:
a main body portion, the main body portion including a plurality of openings extending therethrough;
a plurality of opening forming pins configured to be disposed in a respective one of each of the plurality of openings; and
a reduced portion, the reduced portion being a portion of the main body portion and being configured to encapsulate a portion of each of the plurality of opening forming pins disposed in the openings.

15. The mold core according to claim 14, wherein the reduced portion encapsulates at least half of each of the plurality of opening forming pins in a circumferential direction.
